(19) United States
(12) Patent Application Publication
(10) Pub. No.: US 2009/0248805 A1
(43) Pub. Date: Oct. 1, 2009

(54) Systems and Methods for Communicating Audio/Visual Presentation Materials Between a Presenter and Audience Members

(76) Inventor: George GOMEZ, San Antonio, TX (US)

Correspondence Address: KAMMER BROWNING PLLC, 7700 BROADWAY, SUITE 202, SAN ANTONIO, TX, 78209, US

(21) Appl. No.: 12/414,740

(22) Filed: Mar. 31, 2009

Related U.S. Application Data
(60) Provisional application No. 61/041,589, filed on Apr. 1, 2008.

(51) Int. Cl. G06F 15/16

(52) U.S. Cl. 709/204; 709/228

(57) ABSTRACT

Systems and methods for communicating presentation materials from a presenter to audience members utilizing a number of USB port based devices. The presenter's USB device includes application plug-in software that loads to the presenter's computer and operates in conjunction with a standard application software product (such as PowerPoint® or Keynote®). As the application software runs, the presentation data from the presenter's computer is directed through the presenter's USB device (utilizing a radio frequency (RF) transceiver) to broadcast the presentation data to the audience members. The audience members have each been provided a USB device that includes an RF transceiver for receiving the transmissions from the presenter's USB device. The presentation data would then be communicated into the audience members' computer systems to be run in association with the resident application and plug-in software present. Other materials as might typically take the form of printed documents may likewise be distributed to the audience members. Optional plug-in software components, such as audience feedback and/or voting components, may be integrated into the application plug-in software associated with the USB devices.

### CROSS REFERENCES TO RELATED APPLICATIONS

This application claims the benefit under Title 35 United States Code §119(e) of U.S. Provisional Application 61/041,589 filed Apr. 1, 2008 the full disclosure of which is incorporated herein by reference.

### BACKGROUND OF THE INVENTION

1. Field of the Invention

The present invention relates generally to systems for broadcasting audio/visual materials associated with a presentation to an audience. The present invention relates more specifically to a simplified system for communicating audio/visual presentation materials between a presenter and audience members utilizing and adding to existing application software components.

2. Description of the Related Art

Many professional fields, such as the legal profession and the medical profession, often require ongoing educational activities intended to maintain a level of expertise among members of the field. Such educational activities typically take the form of seminars and conferences where presenters provide to an audience an informative educational presentation, often made up of a combination of printed materials, audio/visual materials, and an oral presentation. Educational activities in general, both those in the above referenced seminar environment and in educational institute environments, such as colleges and universities, frequently take the form of an individual presenter offering a presentation, typically lasting one or more hours of time, that has been prepared specifically for the audience that is in attendance. Sometimes, such a presentation is nothing more than the presenter speaking with the audience listening and perhaps taking notes. More often than not, however, such presentations now involve a combination of the spoken presentation with printed materials and audio/visual materials. A number of efforts have been made in the past to facilitate the various aspects of such an educational presentation.

Systems have been developed to allow a presenter to amplify his or her voice such that the audience members may readily hear and understand the oral presentation being given. In some instances, systems have been developed that allow for the translation of the presenter's language into the disparate languages of various audience members. Such audio systems typically involve microphones, amplification devices, radio frequency (RF) transmitters and receivers, earphones, and intermediate translation personnel, or the like. In a similar fashion, where a presenter has printed materials to be offered to the audience, either as an outline of the presentation being given, or as the complete text and graphics associated with the presentation, efforts have been made in the past to somehow facilitate the transfer of this material from the presenter to the audience members. In most seminar environments this takes the form of having such presentation printed materials published prior to the seminar and distributed to the audience members in binders so that they may bring such materials into the presentation with them.

A further effort has been made in the past to provide methods and systems that allow a presenter to offer audio/visual materials on a large screen display or the like, such that audience members may associate the spoken presentation with specific text and images to further facilitate the transfer of information within the presentation. These systems tend to be based on computer systems that generate images through a projector or similar device that enlarges the images on a screen for the entire audience to view. Software application systems have been developed such as PowerPoint® and Keynote® (and other similar applications) wherein the presenter can prepare in advance sets of audio/visual materials that may be offered as slides or the like in the presentation in concert with the spoken portion of the presentation. Such software applications have become quite complex and versatile in what they allow the presenter to offer in the way of text, visual images, sounds and other live presentation materials.

Recent efforts to further facilitate the transfer of information between the presenter and an audience in an educational environment such as described above, have often involved the establishment of complex communication systems between the presenter and the individual audience members. Examples of these efforts often include systems that communicate between individual computer systems that may be utilized by the presenter and separately by the individual audience members. U.S. Pat. No. 6,728,753 issued to Parasnis et al. on Apr. 27, 2004, entitled Presentation Broadcasting describes a system and method for broadcasting a presentation over a computer network primarily to an on-line audience. The system described is intended to allow a live presentation that includes presentation slides and audio/visual content be broadcast to a number of receiving computers over a network such that the presentation slides are displayed and the audio/visual content is replicated on the receiving computers as it would be in a live presentation.

A similar system is disclosed in U.S. Pat. No. 6,904,451 issued to Orfitelli et al. on Jun. 7, 2005, entitled Wireless Networked Presentation System. The Orfitelli et al. system discloses a broadcasting presentation system having centrally controlled audio and video devices that include a digital projector, a central command processor, and wireless local area network connections. The system anticipates the use of a wide variety of wireless components that are software driven to allow the sharing of text images and sound. These components include digital projectors, personal computers, wireless microphones, touch screen displays, remote control devices, digital cameras (associated with copy stands), wireless speakers, and even wirelessly controlled lighting.

The complexity of the systems described above generally prohibits their easy implementation within the basic educational presentation environment. The systems described tend to be extremely expensive, technically complex to set up and run, and subject to frequent technical difficulties associated with broken communication lines and inadequate control features. The systems that utilize established computer networks, either local area networks or wide area networks, likewise tend to be subject to the complexities of the network communications they are associated with. Any system that relies upon the use of a wide area network, such as the Internet, is of course subject to all of the difficulties associated with bandwidth and wireless access that commonly complicate the use of wide area networks for communicating audio/visual materials. Systems that attempt to involve many different components into an educational presentation environment are difficult to implement with transient audience members such as those who might be attending a seminar on a one time basis. In other words, the complexities of the system and the necessity of establishing in advance the software applications required to operate the complex system often prohibit their use in conjunction with seminar environments where audience members move in and out of individual presentations with great frequency.

It would be desirable to have a system that provided basic communication between a presenter and audience members that involved printed materials (in digital form) as well as audio/visual materials that might typically be presented using standard presentation application software systems (such as PowerPoint® and Keynote® applications). It would be desirable if such a system could be easily implemented in conjunction with both the presenter's computer system and the individual audience members' computer systems, typically in the form of laptop computers. It would be desirable if such a system could be implemented through the simple distribution of small USB port based devices that allowed communication between the presenter's computer and the audience members' computers through a proprietary (or non-proprietary) wireless transmission protocol that allowed the audience members' computer systems to operate standard presentation applications software in conjunction with plug-in modules provided on the USB devices, and thereby to receive in real time the application presentation materials being offered by the presenter. It would further be beneficial if such devices distributed to the audience members included or could be structured to receive certain published components of the presenter's presentation as might otherwise have been intended to be distributed in the form of printed materials. Such additional materials could take the form of a summary or syllabus of the presentation that the audience members might follow or utilize for the purposes of taking electronic notes.

### SUMMARY OF THE INVENTION

In fulfillment of the above objectives the present invention provides systems and methods for communicating presentation materials from a presenter to audience members utilizing a number of USB port based devices plugged into both the presenter's computer and the audience members' computers. The presenter's USB device includes application plug-in software that would load to the presenter's computer and operate in conjunction with a standard application software product (such as PowerPoint® or Keynote®), and as the application software was running, would communicate the presentation data from the presenter's computer through the presenter's USB device (utilizing a radio frequency (RF) transceiver within the USB device) to broadcast the presentation data to the audience members. The audience members would each have been provided an audience member USB device that, in a manner similar to that of the presenter's device, would include a radio frequency (RF) transceiver for receiving the transmissions from the presenter's USB device. These RF transmissions would be communicated through the audience members' USB device into the audience members' computers, which had previously been similarly uploaded with the proprietary application plug-in software. The presentation data would then be communicated into the audience members' computer systems to be run in association with the resident application software present. In this manner, the application software that is offered in the presentation material to the entire audience, such as on a display screen or the like, would simultaneously be transmitted to individual audience members' computers and be presented therein for easier access by that audience member. Other materials as might typically take the form of printed documents could be distributed to the audience members by likewise transmitting such materials into the USB device that the audience members receive. Optional plug-in software components, such as audience feedback and/or voting components, could be integrated into the application plug-in software associated with the USB devices. In this manner, a simplified system involving only small portable USB port transceiver devices that incorporate memory components, RF transceivers, and application plug-in software components, can be utilized to facilitate the transfer of information between a presenter and audience members in an educational presentation environment.

Further objectives of the present invention will become apparent from an understanding of the following detailed description and the attached drawing figures which may be briefly described as follows.

### BRIEF DESCRIPTION OF THE DRAWINGS

FIG. 1 is a partially schematic diagram of an educational presentation environment including electronic systems associated with the presenter and electronic systems (computers) associated with a number of audience members.

FIG. 2 is a schematic block diagram showing the functional components of the presentation system of the present invention.

FIG. 3 is a flowchart providing the upper level implementation methodology of the system of the present invention.

FIG. 4A is a flowchart disclosing the steps in the detailed methodology for providing presenter USB flash drives and transceivers for use in the system of the present invention (Step 100 in FIG. 3).

FIG. 4B is a flowchart disclosing the detailed methodology for providing audience members USB flash drives and transceivers for implementation within the system of the present invention (Step 102 in FIG. 3).

FIG. 5A is a flowchart showing the detailed methodology for activating a presenter USB device on the presenter computer system for use in the system of the present invention (Step 108 in FIG. 3).

FIG. 5B is a flowchart showing the detailed methodology for activating audience member USB devices on audience member computer systems for use in the system of the present invention (Step 110 in FIG. 3).

FIG. 6 is a flowchart disclosing the detailed methodology for opening and executing a presentation on the presenter's computer system and on audience member computer systems (Step 112 in FIG. 3).

### DETAILED DESCRIPTION OF THE PREFERRED EMBODIMENTS

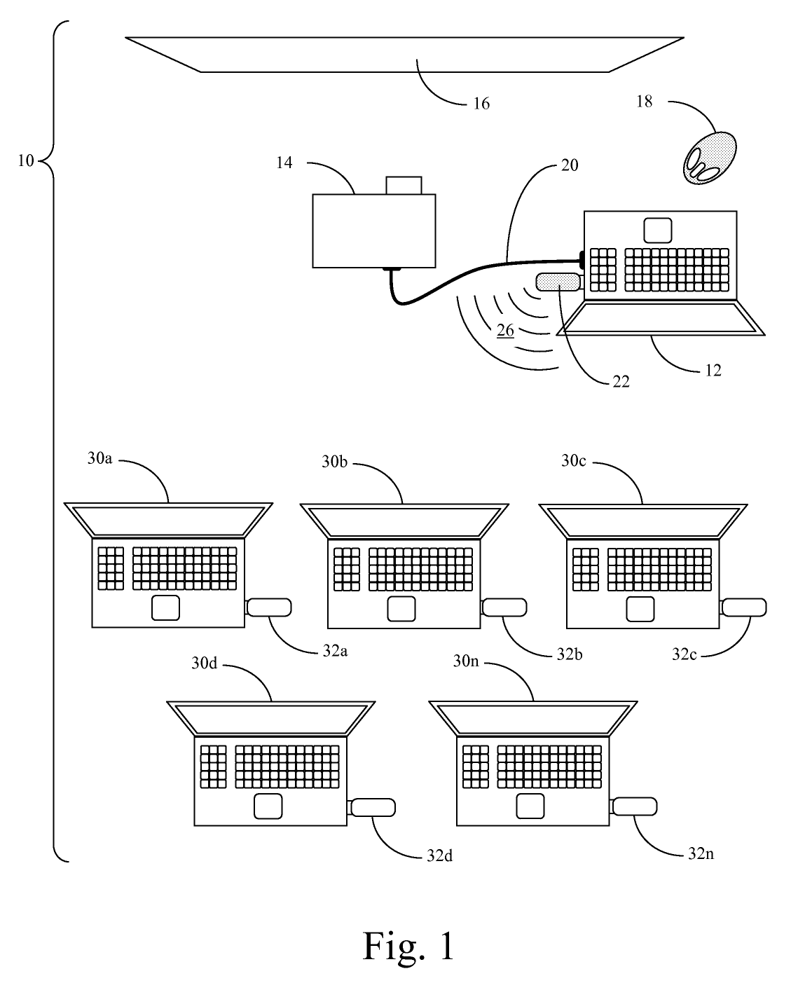

Reference is made first to FIG. 1 for a description of the overall environment within which the systems and methods of the present invention operate to facilitate the transfer of educational information between a presenter and audience members. Presentation communication system 10 is generally comprised of a presenter computer system 12 positioned in a central location within the educational presentation environment. Such a presenter computer system 12 is typically connected to a presentation projection device 14 which projects audio/visual material onto a presentation screen 16. The presenter controls the presentation through a typical presentation application software running on the presenter's computer system 12 (such as with a PowerPoint® presentation or the like). Control of the advancement of the audio/visual presentation is typically carried out through the use of a presenter controller 18 that the presenter may hold and use to progress through the audio/visual presentation as he or she provides a spoken portion of the presentation. The presenter computer system 12 may be hardwired to the presentation projection device 14, although more recently such electronic linkages may involve a wireless communication between a laptop computer and the projection device. In the example shown in FIG. 1, presenter's computer system 12 is connected to presentation projection device 14 by way of a VGA signal cable 20 which communicates a display signal to the presentation projection device 14 which thereby displays the output of the presentation application software.

In the present invention, the presenter computer system 12 would additionally include presenter's USB system device 22 plugged into an available USB port. This presenter USB system device 22 of the present invention would broadcast a proprietary system RF signal 26 to the audience members for reception by individual audience member USB devices as described in more detail below.

As indicated above, it is typical for seminar attendees or audience members to bring with them into the presentation their own computer systems in the form of laptop computers or even PDAs and the like. Such personal computer systems allow audience members to take notes or otherwise review materials that may have been presented to the audience members previous to the live presentation. FIG. 1 shows a plurality of representative audience member computer systems 30a-30n. Each of these audience member computer systems incorporate audience member USB system devices 32a-32n. These audience members would have been provided with these USB system devices 32a-32n at the time they registered for the educational presentation seminar or the like and would generally include some mechanism for verifying the attendance of the audience member at that particular presentation.

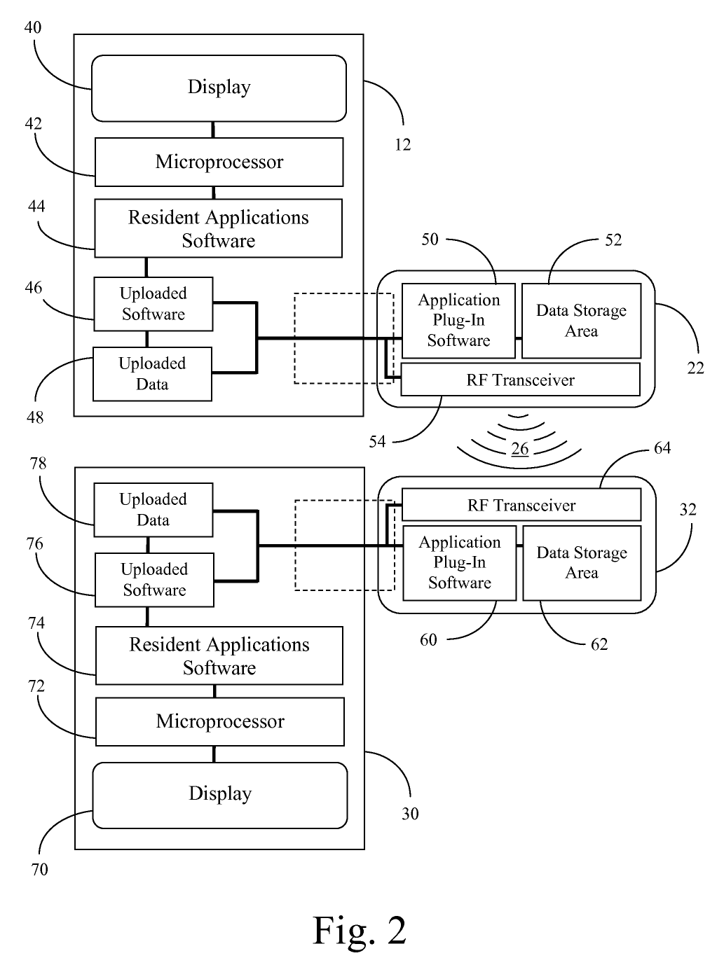

Reference is now made to FIG. 2 for a more detailed description of the operational components of the system of the present invention as they are established to carry out the functionality and methodology of the system. FIG. 2 discloses a presenter's computer system 12 connected to a presenter's USB system device 22. FIG. 2 also discloses in parallel a typical audience member computer system 30 and the connected audience member USB system device 32. Presenter computer system 12 is generally comprised of presenter computer display 40 and presenter computer microprocessor 42. These components represent the basic hardware components of the typical laptop computer. Presenter computer system 12 likewise incorporates presenter resident applications software 44 which in the present invention would include one of a number of standard presentation software applications (such as PowerPoint®, Keynote®, or one of a number of other types of application software). Such resident applications software 44 would of course be provided within the presenter's computer system, memory storage devices such as the laptop computer's disc drive, and, upon activation, in the laptop computer's memory.

In a manner described in more detail below, connecting the presenter USB system device 22 to the presenter's computer system 12 initiates a process of uploading the application plug-in software of the present invention into the digital storage devices of the presenter's computer. This uploaded material takes the form of uploaded software 46 and uploaded data 48. Uploaded software 46, again as described in more detail below, comprises the necessary application plug-in software that is initially resident on the presenter's USB system device. Application plug-in software 50 on the USB device 22 comprises that plug-in software necessary to allow the presenter to communicate the presentation data from the resident application software into the USB device 22 and thereafter to be broadcast to the audience members.

USB device 22, utilized by the presenter in this case, includes RF transceiver 54 which broadcasts the proprietary system RF signal 26 from the presenter's USB device to the audience member's USB system device 32. Further facilitating the data transfer between the presenter's computer system 12 and the presenter's USB system device 22 is data storage area 52 that may optionally have been pre-loaded with information onto the presenter's USB device by the organization providing the system to the users. The manner in which the presenter's USB device 22 is initially used to operate in conjunction with the presenter's computer system 12 and the manner in which presentation data is communicated through the USB device to the audience members is described in more detail below.

The typical audience member's computer system 30 is likewise made up of hardware components that include audience member computer display 70 and audience member computer microprocessor 72. Here again, these hardware components are typically structured within a personal computer system such as a laptop computer. Similar resident applications software 74 is already installed on the typical audience member's computer system 30. In a similar manner, additional software in the form of uploaded software 76 is provided to the audience member's computer 30 by way of connecting the audience member's USB system device 32. Plugging the USB system device 32 into the audience member's computer system 30 uploads application plug-in software 60 into the audience member's computer system 30 to form uploaded software 76. In a similar manner, optional data storage area 62, resident on audience member's USB system device 32, may be uploaded in the form of uploaded data 78 to the typical audience member's computer 30. RF transceiver 64, present on USB device 32, receives transmission signals 26 from the presenter's USB device 22 and communicates the received signal as further audio/visual presentation data into the audience member's computer system in the form of additional uploaded data 78. This uploaded data is utilized according to processes within the uploaded software (the application plug-in software 60 which has been uploaded as uploaded software 76) and operates in conjunction with resident application software 74. In this manner, the material communicated is automatically integrated into a presentation that runs according to resident application software protocols on the audience member's computer system 30.

In addition to the real time transmission of presentation audio/visual material communicated through the USB devices of the present system to the audience member for display on the audience member's computer, certain other presentation material may be incorporated into presentation data 62 and displayed through other standard resident application software systems on the audience member's computer. For example, presentation data might take the form of PDF formatted files that may be displayed on the audience member's computer as one or more pages in a document comprising a syllabus, an outline, or a summary of the presentation being given. As is known in the field, such visual documentation might be viewed by the audience member at the same time as a slide presentation software application might be providing the audio/visual material associated with the presentation and received through the USB communication system. Optionally, the system of the present invention may include the ability to communicate the audio portion of the presenter's spoken presentation into a microphone connected to the presenter's computer, through the USB transceiver devices of the presenter's computer and the audience members' computers, and thereafter into the audience members' computer system. Preferably, the audio would then be directed into headphones or earphones plugged into the audience members' computer systems so as to avoid interference with those audience members listening to the presentation through the house audio system.

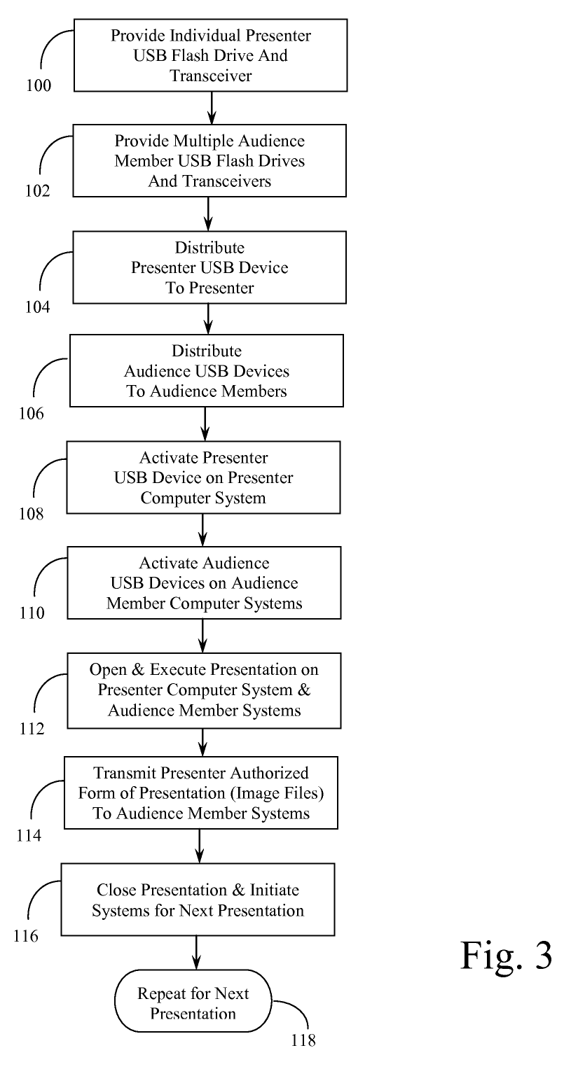

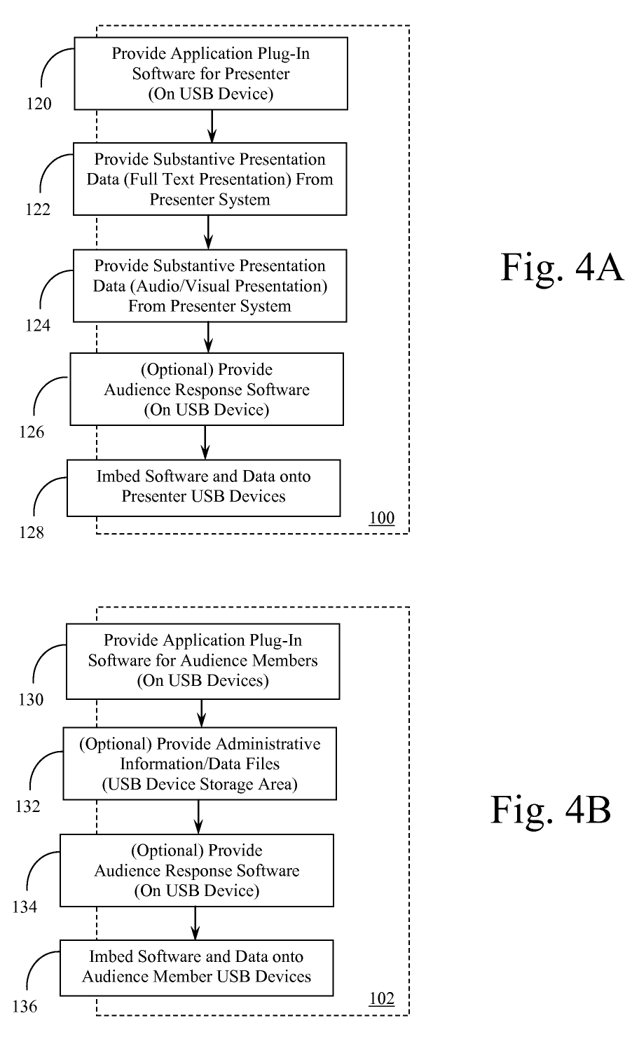

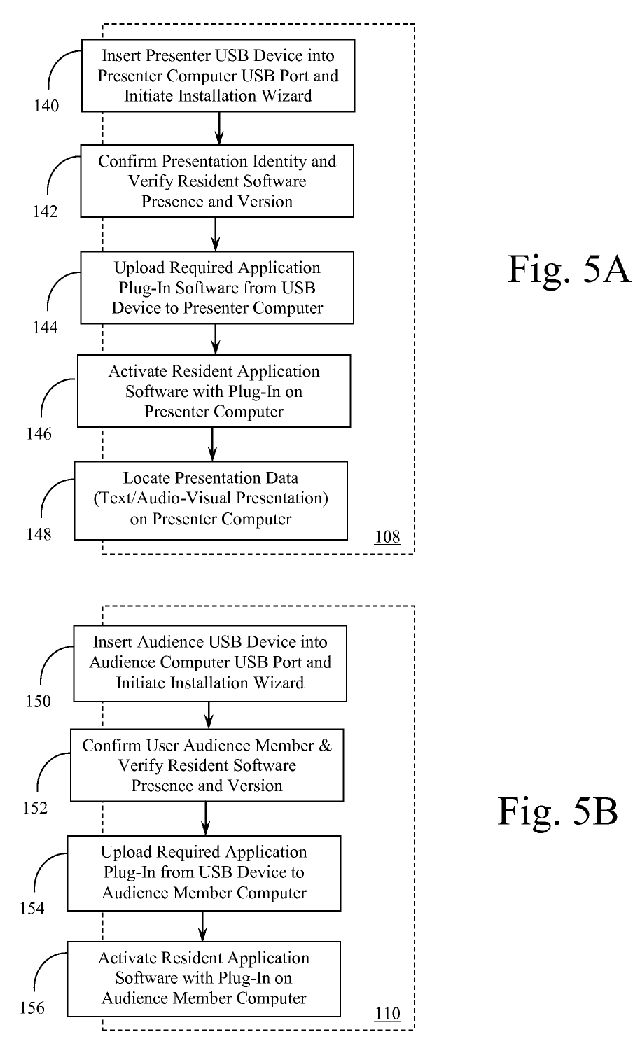

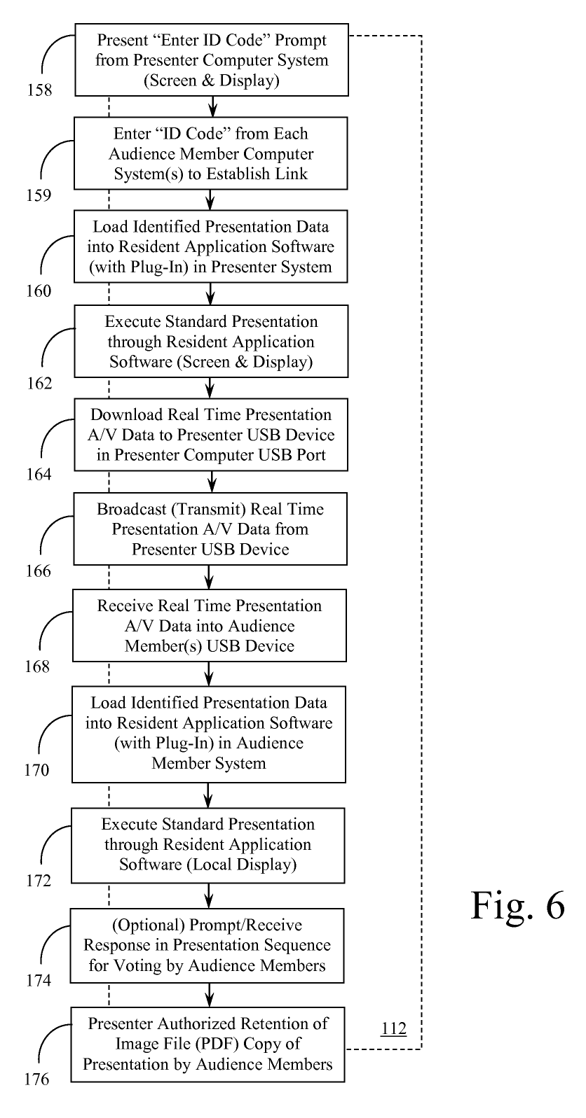

Reference is now made to FIG. 3 for a description of the high level implementation methodology of the system of the present invention. FIGS. 4A-4B and 5A-5B, as well as FIG. 6, disclose more detailed method steps associated with individual method steps shown in FIG. 3. FIG. 3 therefore discloses the broad overall methodology of the present invention while the remaining flowchart figures disclose more detailed steps within that overall methodology.

In FIG. 3 the individual presenter is provided with a USB flash drive and transceiver at Step 100. In a similar manner, at Step 102, multiple audience member USB flash drives and transceivers are provided for operation within the system. Step 104 comprises distribution of the presenter USB device to the presenter for use within the system. In a similar manner Step 106 comprises distribution of the audience USB devices to each of the multiple individual audience members. It should be noted that the distribution of the audience USB devices may occur in any of a number of different manners. The devices may be distributed at the time of the presentation and returned thereafter, or they may be distributed (sold) to individuals who might retain a device for use with many subsequent presentations. The methodology of the present invention does not inherently limit the use of a particular device to a particular presentation as the information specific to the presentation is being transmitted in real time. That is, there need not be anything on an audience members USB device that associates it with a specific presentation. This connection is provided by the aforementioned entry of an ID code at the start of the presentation.

Step 108 involves activation of the presenter USB device on the presenter's computer system at a point in time immediately prior to the actual real time presentation. This allows for the necessary software uploads and the establishment of the operation of the software associated with the actual presentation. In a similar manner, at Step 110, the audience USB devices are activated on the audience member computer systems in the manner and through the steps described in more detail below.

Step 112 involves initiating a communications handshake between the presenter USB device and audience member USB devices after each has been activated on their respective computer systems. This handshake involves confirmation of identification data for a particular presentation and may optionally involve prompting for input from the user to confirm that the particular presentation is appropriate for communication. Step 112 further involves opening and executing the presentation on the presenter's computer system (i.e., activating the PowerPoint® presentation or the like) and similarly activating such application software on each of the individual audience member computer systems. The presentation is carried out in real time between the presenter and the audience members with the various audio/visual materials being communicated. At Step 114, the various “printed” materials that the presenter authorizes for permanent distribution are transmitted to the audience members' USB devices. Finally, at Steps 116 and 118, the presentation is closed and the entire process may be repeated for the next presentation in the same or an adjacent presentation environment.

FIGS. 4A and 4B provide the detailed steps associated with establishing (programming) the necessary USB devices for use by the presenter (FIG. 4A) and for use by each of the individual audience members (FIG. 4B). In FIG. 4A the application plug-in software of the system of the present invention is initially provided in Step 120 for the presenter's use on the presenter's USB device. This application plug-in software is simply a software routine or component module that may be activated in association with standard presentation application software products (such as PowerPoint®) and communicate to the standard presentation software applications, data forming the implementation of the presentation to the USB device for broadcast to the audience members. In a similar manner, Step 122 involves providing substantive presentation data (full text materials or slides and the like) onto the presenter's USB device for use by the presenter during the presentation and/or for real time transmission (at the presenter's option) to the audience members for their use in conjunction with the reception of the presentation. Step 124 involves providing substantive presentation data in the form of the full text of the presentation to the presenter and for use during his or her offering of the presentation in conjunction with the audio visual materials presented separately. It is anticipated that the presenter's USB device may incorporate the entire text of the presentation in the data storage area (mentioned above) to facilitate the presenter's offering of the same in real time but would not be provided to individual audience members beyond its summary or syllabus form as described above. In this manner the presenter is free to allow more or less of the printed presentation materials to be distributed to the audience members for retention. In addition, at Step 126 the presenter's USB device may optionally be provided with audience response plug-in application software such as what might be additionally accessed by the resident presentation application software program. Step 128 involves embedding these components onto the presenter USB device.

FIG. 4B provides the method steps associated with the similar establishment of the typical audience member's USB device. At Step 130 the audience members' USB device is provided with application plug-in software, again specifically configured for utilization by the audience member as opposed to the presenter in association with the application software program. Optionally, administrative information and data may be provided at Step 132. Once again, substantive presentation data may also be pre-loaded onto the audience members' USB device in the form of a PDF file or the like that might be simultaneously viewed by the audience member while the presentation software application is running.

At Step 128 all of the application software plug-in and data is embedded into the presenter's USB device wherein the device is provided to the presenter for use during the presentation. In a similar manner, at Step 136 in FIG. 4B the software and data is embedded onto the audience members' USB device, again for providing the same to the audience member upon registration or upon entering the educational presentation room or seminar location. At Step 134, also an optional step, the audience member's USB device may be provided with a voting or audience response module as part of the application plug-in software. This component would allow audience members, on being prompted by the presenter's presentation broadcast signal communication, to respond by transmitting simple yes/no or numerical responses to queries offered within the presentation.

Reference is now made to FIGS. 5A and 5B for descriptions of method steps associated with implementation of the plug-in software components on each of the presenter computer. Step 140 in FIG. 5A provides the step of inserting the presenter USB device into the presenter computer USB port and initiating an activation wizard routine to proceed through the progressive installation steps. Step 142 confirms the presenter identity and verifies that the necessary resident software is present and is of the proper version. The application plug-in software is designed to operate in conjunction with one or more standard applications of software packages of specific versions in order to function properly. The initial step in the installation and initiation process, therefore, is confirmation of the appropriate resident software being present. Identification data associated with a given presenter is optionally provided to confirm that the information to be contained or communicated on the particular USB device is that associated with the particular presentation.

At Step 144 the required application plug-in software is uploaded from the USB device to the presenter's computer in order to operate in association with the resident application software package. At Step 146 the resident application software with the plug-in as loaded on the presenter's computer is activated for operation. Then at Step 148 the located and updated presentation data (including the summary, the presentation text, and the audio/visual presentation) are identified on the presenter's computer system.

FIG. 5B discloses the method steps associated with similar activation and implementation of the audience member USB device in conjunction with the audience members' computer system. At Step 150 the user inserts the audience member USB device into the audience member computer USB port and initiates an activation wizard software routine to carry out the balance of the process. As with the presenter device, an audience member device is confirmed at Step 152 and the resident application software presence and version is verified. At Step 154 the required application plug-in is uploaded from the USB device to the audience member computer. Finally, at Step 156, the resident application software is activated with the plug-in component on the audience member computer in a manner that establishes it for receipt of the presentation data in real time during the presentation.

Reference is finally made to FIG. 6 for a detailed description of the methodology associated with the actual operation of the system and software of the present invention. At Steps 158 and 159 an initial communication between the presenter and the audience members is carried out to verify and validate the presentation transmission. At Step 160 the identified presentation data is loaded in conjunction with the resident application software with the appropriate up-loaded plug-in on the presenter's computer system. At Step 162 standard presentation process is executed through the resident application software on the screen and display of the presenter's computer and through the connection to the room display device (the presentation projection device described above). The real time presentation audio/visual data is downloaded at Step 164 into the presenter USB device by the plug-in software routine. From the presenter USB device this real time presentation audio/visual data is then broadcast at Step 166 or transmitted in real time from the presenter's USB device through the RF transceiver in the device into the local room area within which the audience members are located. At Step 168 the audience members' USB devices receive in real time the presentation audio/visual data into the RF transceivers associated with each individual audience member USB system device. The real time presentation audio/visual data is then communicated from the audience member USB devices into the audience member computers at Step 170. The standard presentation is executed through resident application software at Step 172 within each audience member's computer system and presented on the local display for the computer system.

As indicated above, an optional component of the presentation system involves a prompt response action at Step 174 within the presentation sequence that allows voting or response actions by the audience members. Subsequent to this optional step the response action (loading or other response) is received and recorded from each of the audience member's USB device, preferably within the presenter's USB device in a manner that allows its integration in real time presentation within the audio/visual portion of the overall presentation.

Finally, at Step 176, “image copies” of the presentation may be provided to the audience members for retention. The choice of what materials to allow the audience members to retain would preferably be within the discretion of the presenter (the author of the materials in most cases). In the preferred embodiment, the presentation software could be directed to effect a “print” function to create (and transmit) a PDF or other image formatted file containing the “slides” of the presentation. Such functionality would take the place of the common slide handouts that are often provided in printed form at such seminars and the like.

Although the present invention has been described in terms of the foregoing preferred embodiments, this description has been provided by way of explanation only, and is not intended to be construed as a limitation of the invention. Those skilled in the art will recognize modifications in the present invention that might accommodate specific educational presentation environments and systems. Such modifications as to structure, method, and even the specific arrangement of components, where such modifications are coincidental to the educational instructional environment or the specific subject matter being presented, do not necessarily depart from the spirit and scope of the invention.

I claim:

1. A system for communicating audio/visual presentation materials between a presenter and audience members, the system comprising:
(a) a presenter computer system, comprising a presenter computer display and a presenter computer microprocessor, the presenter computer system further comprising presenter resident application software comprising a commercially available presentation software application;
(b) a presenter USB system device for connection to the presenter computer system, the presenter USB system device comprising a memory storage component and a data communication component, the memory storage component further comprising plug-in application software operable in conjunction with the commercially available presentation software and further comprising data operable in conjunction with the presentation software;
(c) a plurality of audience member computer systems each comprising an audience member computer display and an audience member computer microprocessor, the audience member computer systems each further comprising audience member resident applications software comprising the commercially available presentation software application; and
(d) a plurality of audience member USB system devices for connection to the plurality of audience member computer systems, each of the audience member USB system devices comprising a memory storage component and a data communication component, the memory storage component further comprising plug-in application software operable in conjunction with the commercially available presentation software and further comprising data operable in conjunction with the presentation software.

2. A method for communicating audio/visual presentation materials between a presenter and audience members, the presenter and the audience members each having a computer system available for their individual use, the method comprising the steps of:
(a) providing the presenter with a combination presenter USB flash drive and transceiver;
(b) providing a plurality of audience members with combination USB flash drives and transceivers for data communication operation with the presenter USB flash drive and transceiver;
(c) activating the presenter USB device on the presenter's computer system at a point in time immediately prior to the presentation, the activation uploading operational software and establishing the operation of the software to carry out the audio/visual presentation;
(d) activating the audience USB devices on the audience member computer systems;
(e) initiating a communications handshake between the presenter USB device and audience member USB devices;
(f) opening and executing the presentation on the presenter's computer system and similarly activating software on each of the individual audience member computer systems; and
(g) carrying out the presentation in real time between the presenter and the audience members with the various audio/visual materials being communicated.
